(19) United States
(12) Patent Application Publication
(10) Pub. No.: US 2025/0189637 A1
(43) Pub. Date: Jun. 12, 2025

(54) APPARATUS AND SYSTEM

(71) Applicant: CANON KABUSHIKI KAISHA, Tokyo (JP)

(72) Inventor: KAZUHIRO MORIMOTO, Kanagawa (JP)

(21) Appl. No.: 18/954,265

(22) Filed: Nov. 20, 2024

(30) Foreign Application Priority Data
Dec. 7, 2023 (JP) 2023-206843

(51) Int. Cl. G01S 7/4863; G01S 17/10

(52) U.S. Cl. CPC G01S 7/4863; G01S 17/10

(57) ABSTRACT

An apparatus including a plurality of photoelectric conversion elements generates a plurality of subframes using signals from the plurality of photoelectric conversion elements, and generates a distance measurement frame using signals of the plurality of subframes, wherein the plurality of subframes includes at least a first subframe in which an exposure period is started after a lapse of a first period after light emission from a light emission element, and a second subframe in which an exposure period is started after a lapse of a second period longer than the first period after the light emission from the light emission element, wherein the first subframe includes at least a first exposure period and a second exposure period, wherein a start timing of the first exposure period and a start timing of the second exposure period are different.

### BACKGROUND

### Technical Field

The aspect of the embodiments relates to an apparatus and a system.

### Description of the Related Art

The specification of United States Patent Application Publication No. 2017/0052065 discusses a distance measurement apparatus that measures a distance to an object by emitting light from a light source and receiving light including reflected light from the object using a light receiving element. In the distance measurement apparatus discussed in the specification of United States Patent Application Publication No. 2017/0052065, a single photon avalanche diode (SPAD) element that acquires a signal by multiplying an electron generated by photoelectric conversion is used as the light receiving element. The specification of United States Patent Application Publication No. 2017/0052065 discusses a distance measurement method of repeatedly performing measurement while varying a start timing of an exposure period (Gating interval) for each subframe in which photon detection is performed in the SPAD element.

In the distance measurement method as discussed in the specification of United States Patent Application Publication No. 2017/0052065, a tradeoff relationship exists between distance resolution and a reduction of a distance measurement time. More specifically, if an exposure period in a subframe is increased, while a distance measurement time is shortened, distance resolution deteriorates. In contrast, if an exposure period in a subframe is decreased, while distance resolution improves, a distance measurement time is increased. Nevertheless, in order to improve distance measurement performance, it may be demanded to ensure appropriate distance resolution without increasing a distance measurement time.

### SUMMARY

According to an aspect of the embodiments, an apparatus includes a plurality of photoelectric conversion elements, wherein the apparatus generates a plurality of subframes using signals from the plurality of photoelectric conversion elements, and generates a distance measurement frame using signals of the plurality of subframes, wherein the plurality of subframes includes at least a first subframe in which an exposure period is started after a lapse of a first period after light emission from a light emission element, and a second subframe in which an exposure period is started after a lapse of a second period longer than the first period after the light emission from the light emission element, wherein the first subframe includes at least a first exposure period and a second exposure period, wherein a start timing of the first exposure period and a start timing of the second exposure period are different.

Further features of the disclosure will become apparent from the following description of exemplary embodiments with reference to the attached drawings.

### BRIEF DESCRIPTION OF THE DRAWINGS

FIG. 1 is a block diagram illustrating a schematic configuration of a distance information generation apparatus according to an exemplary embodiment.

FIG. 2 is a schematic diagram illustrating a photoelectric conversion apparatus included in a signal generation apparatus according to an exemplary embodiment.

FIG. 3 is a diagram illustrating the arrangements in a sensor substrate of a photoelectric conversion apparatus according to an exemplary embodiment.

FIG. 4 is a diagram illustrating a configuration of a circuit substrate of a photoelectric conversion apparatus according to an exemplary embodiment.

FIG. 5 illustrates a configuration example of a pixel circuit of a photoelectric conversion apparatus according to an exemplary embodiment.

FIG. 6A is a schematic diagram illustrating driving of a pixel circuit of a photoelectric conversion apparatus according to an exemplary embodiment.

FIG. 6B is a schematic diagram illustrating driving of a pixel circuit of a photoelectric conversion apparatus according to an exemplary embodiment.

FIG. 6C is a schematic diagram illustrating driving of a pixel circuit of a photoelectric conversion apparatus according to an exemplary embodiment.

FIG. 7 is a driving timing diagram according to a comparative exemplary embodiment.

FIG. 8A illustrates a graph indicating gate driving per unit time in driving and an effective gate profile according to a comparative exemplary embodiment.

FIG. 8B illustrates a graph indicating gate driving per unit time in driving and an effective gate profile according to a comparative exemplary embodiment.

FIG. 9 is a driving timing diagram according to a first exemplary embodiment.

FIG. 10A illustrates a graph indicating gate driving per unit time in driving and an effective gate profile according to the first exemplary embodiment.

FIG. 10B illustrates a graph indicating gate driving per unit time in driving and an effective gate profile according to the first exemplary embodiment.

FIG. 11A illustrates a graph indicating gate driving per unit time in driving and an effective gate profile according to a second exemplary embodiment.

FIG. 11B illustrates a graph indicating gate driving per unit time in driving and an effective gate profile according to the second exemplary embodiment.

FIG. 12A illustrates a graph indicating gate driving per unit time in driving and an effective gate profile according to a modified example of the second exemplary embodiment.

FIG. 12B illustrates a graph indicating gate driving per unit time in driving and an effective gate profile according to the modified example of the second exemplary embodiment.

FIG. 12C illustrates a graph indicating gate driving per unit time in driving and an effective gate profile according to the modified example of the second exemplary embodiment.

FIG. 13A illustrates a graph indicating gate driving per unit time in driving and an effective gate profile according to a third exemplary embodiment.

FIG. 13B illustrates a graph indicating gate driving per unit time in driving and an effective gate profile according to a third exemplary embodiment.

FIG. 14A illustrates a graph indicating gate driving per unit time in driving and an effective gate profile according to a fourth exemplary embodiment.

FIG. 14B illustrates a graph indicating gate driving per unit time in driving and an effective gate profile according to the fourth exemplary embodiment.

FIG. 15A illustrates a graph indicating gate driving per unit time in driving and an effective gate profile according to Modified Example 1 of the fourth exemplary embodiment.

FIG. 15B illustrates a graph indicating gate driving per unit time in driving and an effective gate profile according to Modified Example 1 of the fourth exemplary embodiment.

FIG. 16A illustrates a graph indicating gate driving per unit time in driving and an effective gate profile according to Modified Example 2 of the fourth exemplary embodiment.

FIG. 16B illustrates a graph indicating gate driving per unit time in driving and an effective gate profile according to Modified Example 2 of the fourth exemplary embodiment.

FIG. 17A illustrates a graph indicating gate driving per unit time in driving and an effective gate profile according to Modified Example 3 of the fourth exemplary embodiment.

FIG. 17B illustrates a graph indicating gate driving per unit time in driving and an effective gate profile according to Modified Example 3 of the fourth exemplary embodiment.

FIG. 18A illustrates a graph indicating gate driving per unit time in driving and an effective gate profile according to a fifth exemplary embodiment.

FIG. 18B illustrates a graph indicating gate driving per unit time in driving and an effective gate profile according to the fifth exemplary embodiment.

FIG. 19A illustrates a graph indicating gate driving per unit time in driving and an effective gate profile according to a comparative example of the fifth exemplary embodiment.

FIG. 19B illustrates a graph indicating gate driving per unit time in driving and an effective gate profile according to the comparative example of the fifth exemplary embodiment.

FIG. 20 is a functional block diagram of a signal generation system according to a sixth exemplary embodiment.

FIG. 21A is a functional block diagram of a signal generation system according to a seventh exemplary embodiment.

FIG. 21B is a functional block diagram of a signal generation system according to the seventh exemplary embodiment.

FIG. 22A is a functional block diagram of a signal generation system according to an eighth exemplary embodiment.

FIG. 22B is a functional block diagram of a signal generation system according to the eighth exemplary embodiment.

FIG. 23A is a functional block diagram of a signal generation system according to a ninth exemplary embodiment.

FIG. 23B is a functional block diagram of a signal generation system according to the ninth exemplary embodiment.

### DESCRIPTION OF THE EMBODIMENTS

The following exemplary embodiments are provided to embody the technical idea of the present disclosure, and are not intended to limit the present invention. The sizes and the positional relationship of members illustrated in the drawings may be exaggerated to clarify the description. In the following description, the same components are assigned the same reference numerals, and the description thereof may be omitted.

Hereinafter, exemplary embodiments of the present disclosure will be described in detail with reference to the drawings. In the following description, terms indicating specific directions and positions (e.g., “up”, “down”, “right”, “left”, and other terms including these terms) are used as appropriate. These terms are used to facilitate the understanding of the exemplary embodiments to be described with reference to the drawings. The technical scope of the present disclosure is not limited by the meanings of these terms.

In this specification, a “plane” refers to a surface viewed from a direction vertical to a light incidence surface of a semiconductor layer. A cross-section refers to a surface in the direction vertical to the light incidence surface of the semiconductor layer. In a case where the light incidence surface of the semiconductor layer is a rough surface when viewed microscopically, a plane is defined based on the light incidence surface of the semiconductor layer that is viewed macroscopically.

In the following description, an anode of an avalanche photodiode (APD) is set to a fixed potential, and a signal is taken out from a cathode side. Accordingly, a semiconductor region of a first conductivity type having a charge of the same polarity as a signal charge as a majority carrier is an N-type semiconductor region, and a semiconductor region of a second conductivity type having a charge of a polarity different from a signal charge as a majority carrier is a P-type semiconductor region. Even in a case where a cathode of an APD is set to a fixed potential, and a signal is taken out from an anode side, the exemplary embodiments of the present disclosure can be implemented. In this case, the semiconductor region of the first conductivity type having a charge of the same polarity as a signal charge as a majority carrier is the P-type semiconductor region, and the semiconductor region of the second conductivity type having a charge of a polarity different from a signal charge as a majority carrier is the N-type semiconductor region. The following description will be given of a case where one node of an APD is set to a fixed potential, but potentials at both nodes may be made variable.

In the following exemplary embodiments, the connection between elements of circuits may be described. In this case, even in a case where another element is interposed between elements to be observed, unless otherwise noted, the elements to be observed are regarded as being connected. For example, it is assumed that an element A is connected to one node of a capacitative element C having a plurality of nodes, and an element B is connected to the other node. Even in such a case, unless otherwise noted, the elements A and B are regarded as being connected.

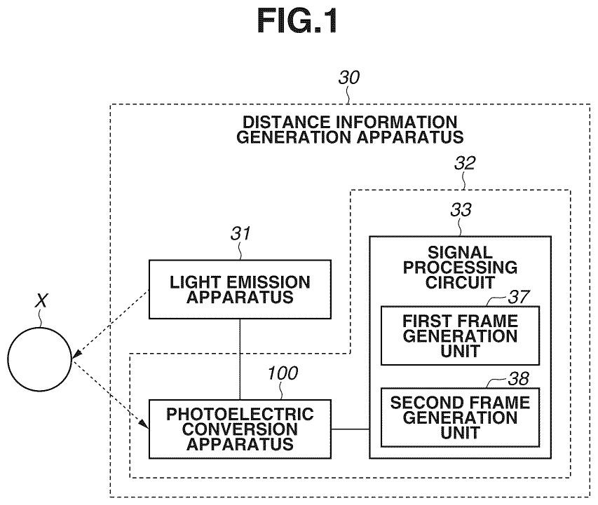

FIG. 1 is a hardware block diagram illustrating an example of a schematic configuration of a distance information generation apparatus 30 according to an exemplary embodiment. The distance information generation apparatus 30 includes a light emission apparatus 31, a signal generation apparatus 32, and a signal processing circuit 33. The signal generation apparatus 32 can include a photoelectric conversion apparatus 100 and the signal processing circuit 33. The configuration of the distance information generation apparatus 30 illustrated in FIG. 1 is merely an example, and the configuration of the distance information generation apparatus 30 is not limited to the configuration illustrated in FIG. 1. For example, a first frame generation unit 37 and a second frame generation unit 38 that are included in the signal processing circuit 33 may be included in the photoelectric conversion apparatus 100.

The distance information generation apparatus 30 is an apparatus that measures a distance to a target object X as a distance measurement target using a technique, such as Light Detection and Ranging (LiDAR). The distance information generation apparatus 30 measures a distance from the distance information generation apparatus 30 to the target object X based on a time lag from emission of light from the light emission apparatus 31 until the light is reflected by the target object X and received by the photoelectric conversion apparatus 100. The distance information generation apparatus 30 can also emit laser light within a predetermined distance measurement range including the target object X and two-dimensionally measure distances at a plurality of points by receiving reflected light by a pixel array. The distance information generation apparatus 30 can thereby output distance information. Alternatively, the distance information generation apparatus 30 may output image information that is based on distance information (image information including a color difference and a contrast difference that correspond to distance information).

The light to be received by the signal generation apparatus 32 contains environmental light, such as solar light, in addition to reflected light from the target object X. Thus, the distance information generation apparatus 30 performs distance measurement with reduced influence of environmental light using a method of measuring a light amount of incident light in each of a plurality of periods (bin periods) and determining that reflected light has entered in a period in which a light amount has reached a peak.

The light emission apparatus 31 is an apparatus that emits light, such as laser light, to the outside of the distance information generation apparatus 30. A vertical cavity surface emitting laser (VCSEL) that can be easily formed in a two-dimensional array, for example, may be for the laser light.

The signal processing circuit 33 can include a processor that performs calculation processing on digital signals, and a memory that stores digital signals. As the memory, for example, a semiconductor memory can be used. The distance information generation apparatus 30 does not necessarily include the signal processing circuit 33. In this case, at least a part of the configurations included in the signal processing circuit 33 is provided in the photoelectric conversion apparatus 100. In this case, the signal generation apparatus 32 and the photoelectric conversion apparatus 100 are the same.

The signal generation apparatus 32 generates a pulse signal including a pulse that is based on incident light. In the present exemplary embodiment, the photoelectric conversion apparatus 100 included in the signal generation apparatus 32 generates a pulse signal. For example, a photoelectric conversion apparatus including an APD as a photoelectric conversion element can be used. In this case, if one photon enters the APD and a charge is generated, one pulse is generated by avalanche multiplication. The photoelectric conversion apparatus 100 included in the signal generation apparatus 32 is not limited to a photoelectric conversion apparatus that uses an APD as a photoelectric conversion element, and may be a photoelectric conversion apparatus that uses a different photodiode as a photoelectric conversion element.

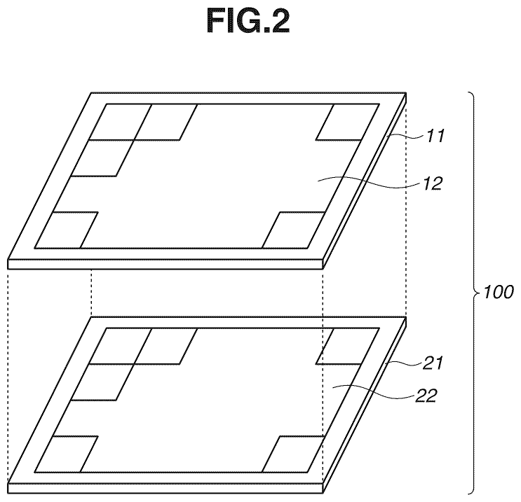

In the present exemplary embodiment, the photoelectric conversion apparatus 100 includes a pixel array in which a plurality of photoelectric conversion elements (pixels) is arranged over a plurality of rows and a plurality of columns. The photoelectric conversion apparatus 100 will now be described with reference to FIGS. 2 to 6C. The configuration of the photoelectric conversion apparatus to be described below is merely an example. The photoelectric conversion apparatus is not limited to this, and any photoelectric conversion apparatus may be used as long as it makes it possible to implement the function of each exemplary embodiment to be described below.

FIG. 2 is a diagram illustrating a configuration of a stack-type photoelectric conversion apparatus 100 included in the distance information generation apparatus 30. The photoelectric conversion apparatus 100 includes two stacked substrates corresponding to a sensor substrate 11 (first substrate) and a circuit substrate 21 (second substrate) that are electrically connected. The sensor substrate 11 includes a first semiconductor layer including a photoelectric conversion unit 102 to be described below, and a first wiring structure. The circuit substrate 21 includes a second semiconductor layer including a signal detection circuit, such as a signal processing unit 103 to be described below, and a second wiring structure. The photoelectric conversion apparatus 100 includes the second semiconductor layer, the second wiring structure, the first wiring structure, and the first semiconductor layer, which are stacked in this order. The photoelectric conversion apparatus 100 described in each exemplary embodiment is a back-illuminated photoelectric conversion apparatus in which light enters from the side of a first surface of the first semiconductor layer of the sensor substrate 11, and a circuit substrate is arranged on a second surface facing the first surface of the first semiconductor layer of the sensor substrate 11.

Hereinafter, the sensor substrate 11 and the circuit substrate 21 will be described as chips singulated by dicing, but the sensor substrate 11 and the circuit substrate 21 are not limited to chips. For example, the sensor substrate 11 and the circuit substrate 21 may be wafers. Alternatively, the sensor substrate 11 and the circuit substrate 21 may be singulated by dicing after being stacked in a state of wafer, or may be chipped in a state of wafer and then jointed by stacking chips.

A photoelectric conversion region 12 in which a plurality of photoelectric conversion elements is arranged in a two-dimensional array is arranged on the sensor substrate 11, and a circuit region 22 for processing signals detected in the photoelectric conversion region 12 is arranged on the circuit substrate 21.

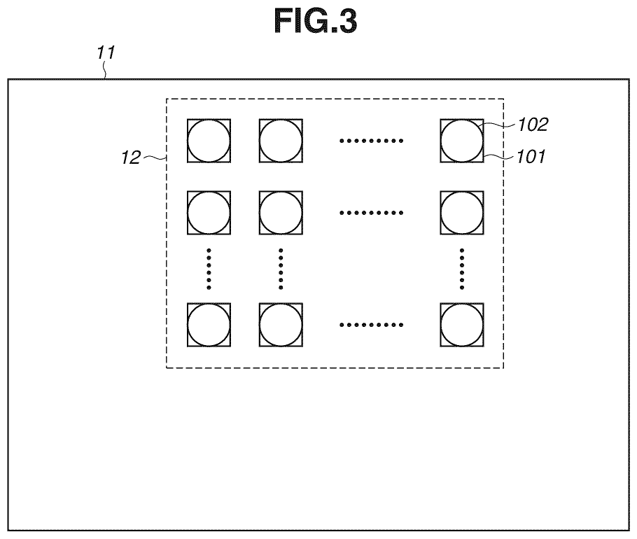

FIG. 3 is a diagram illustrating an example of arrangements in the sensor substrate 11. Photoelectric conversion elements 101 each including the photoelectric conversion unit 102 including an APD are arranged in a two-dimensional array in a planar view and form the photoelectric conversion region 12.

The photoelectric conversion element 101 suffices it can measure a time at which light reaches, and a light amount.

For example, in a case where the photoelectric conversion element 101 is used in a time of flight (TOF) sensor, an image is not necessarily formed. Nevertheless, the photoelectric conversion element 101 may be a pixel for forming an image.

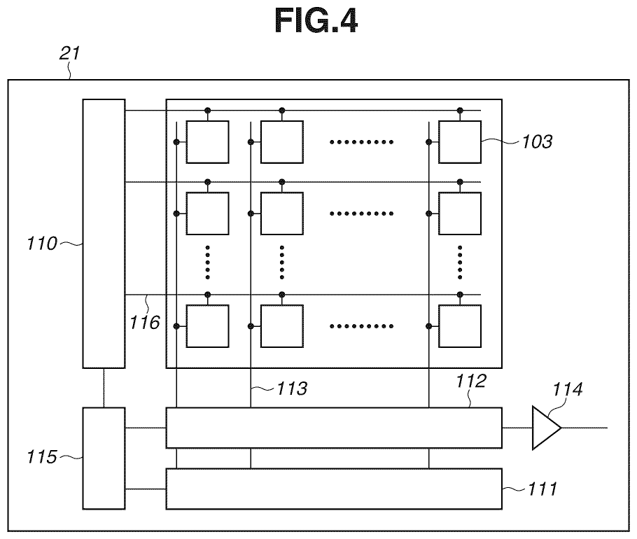

FIG. 4 is a configuration diagram of the circuit substrate 21. The circuit substrate 21 includes the signal processing units 103 that each processes a charge photoelectrically converted by the photoelectric conversion unit 102 illustrated in FIG. 2, a readout circuit 112, a control pulse generation unit 115, a horizontal scanning circuit unit 111, signal lines 113, a vertical scanning circuit unit 110, an output circuit 114, and drive lines 116.

Each of the photoelectric conversion units 102 illustrated in FIG. 3 and a corresponding one of the signal processing units 103 illustrated in FIG. 4 are electrically connected via a connection wire provided for each photoelectric conversion element.

The vertical scanning circuit unit 110 receives a control pulse supplied from the control pulse generation unit 115, and supplies the control pulse to each photoelectric conversion element via the drive lines 116. A logic circuit, such as a shift register or an address decoder, is used as the vertical scanning circuit unit 110.

A signal output from the photoelectric conversion unit 102 of each photoelectric conversion element 101 is processed by a corresponding one of the signal processing units 103. A counter and a memory are provided in each signal processing unit 103, and a digital value is stored in the memory.

The horizontal scanning circuit unit 111 inputs, to the signal processing units 103, a control pulse for sequentially selecting each column, in order to read out a signal from the memory of each photoelectric conversion element 101 that stores a digital signal.

A signal is output to the signal line 113 from the signal processing unit 103 of a photoelectric conversion element on a selected column that has been selected by the vertical scanning circuit unit 110.

The signal output to the signal line 113 is output via the output circuit 114 to a recording unit or a signal processing unit that is provided on the outside of the photoelectric conversion apparatus 100.

In FIG. 2, the photoelectric conversion units in the photoelectric conversion region may be one-dimensionally arrayed. The function of the signal processing unit is not necessarily provided for each of all photoelectric conversion units. For example, one signal processing unit may be shared by a plurality of photoelectric conversion units, and signal processing may be sequentially performed.

As illustrated in FIGS. 3 and 4, a plurality of signal processing units 103 is arranged in a region overlapping the photoelectric conversion region 12 in a planar view. Then, the vertical scanning circuit unit 110, the horizontal scanning circuit unit 111, the readout circuit 112, the output circuit 114, and the control pulse generation unit 115 are arranged in a region between the edge of the sensor substrate 11 and the edge of the photoelectric conversion region 12 in a planar view. In other words, the sensor substrate 11 includes the photoelectric conversion region 12 and a non-photoelectric conversion region arranged around the photoelectric conversion region 12. Then, the vertical scanning circuit unit 110, the horizontal scanning circuit unit 111, the readout circuit 112, output circuit 114, and the control pulse generation unit 115 are arranged in a region overlapping the non-photoelectric conversion region in a planar view.

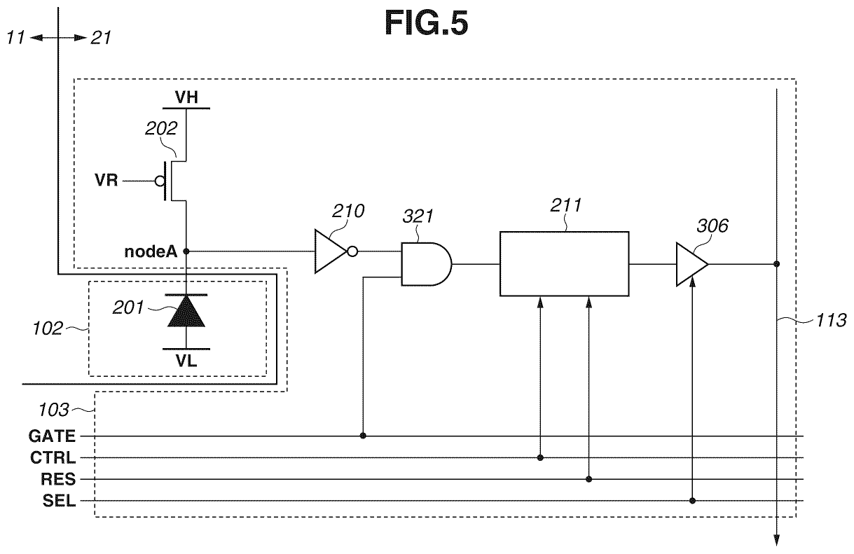

FIG. 5 is a block diagram illustrating an example of a photoelectric conversion element including the equivalent circuit illustrated in FIGS. 3 and 4. FIG. 5 illustrates a block diagram of a photoelectric conversion element including a typical APD.

In FIG. 5, the photoelectric conversion unit 102 including an APD 201 is provided on the sensor substrate 11, and other members are provided on the circuit substrate 21.

The APD 201 generates a charge pair corresponding to incident light by photoelectric conversion. A voltage VL (first voltage) is supplied to an anode of the APD 201. A voltage VH (second voltage) higher than the voltage VL supplied to the anode is supplied to a cathode of the APD 201. A reverse bias voltage for causing the APD 201 to perform an avalanche multiplication operation is supplied to the anode and the cathode. By supplying such voltages to the APD 201, a charge generated by incident light causes avalanche multiplication, and an avalanche current is generated.

In a case where a reverse bias voltage is supplied, the APD 201 is operated in a Geiger mode or a linear mode. In the Geiger mode, the APD 201 is operated with a potential difference between the anode and the cathode that is larger than a breakdown voltage. In the linear mode, the APD 201 is operated with a potential difference between the anode and the cathode that is near the breakdown voltage or equal to or smaller than the breakdown voltage.

An APD operated in the Geiger mode will be referred to as a single photon avalanche diode (SPAD). For example, the voltage VL is −30 V and the voltage VH is 1 V. The APD 201 may be operated in the linear mode or may be operated in the Geiger mode.

A quench element 202 is connected to the APD 201 and a power source that supplies the voltage VH. The quench element 202 functions as a load circuit (quench circuit) when a signal is multiplied by avalanche multiplication, and has a function of suppressing avalanche multiplication by reducing a voltage to be supplied to the APD 201 (quench operation). The quench element 202 also has a function of returning a voltage to be supplied to the APD 201 to the voltage VH by allowing a current corresponding in amount to a voltage drop caused by the quench operation to flow (recharge operation).

In FIG. 5, the quench element 202 is constituted by a transistor, and a potential is supplied to a gate of the quench element 202 via a drive line VR. The potential supplied from the drive line VR is a reset signal that resets a cathode potential at a node A of the APD 201 by switching a resistance value of the quench element 202.

The signal processing unit 103 includes a waveform shaping unit 210, a gate circuit 321 (first selection circuit), a counter 211, and an output circuit 306 (second selection circuit). In this specification, in one embodiment, the signal processing unit 103 includes any of the waveform shaping unit 210, the gate circuit 321, the counter 211, and the output circuit 306.

The waveform shaping unit 210 outputs a pulse signal by shaping a potential change of the cathode of the APD 201 that is obtained at the time of photon detection. For example, an inverter circuit is used as the waveform shaping unit 210. FIG. 5 illustrates an example in which one inverter is used as the waveform shaping unit 210, but a circuit in which a plurality of inverters is connected in series may be used as the waveform shaping unit 210, or another circuit having a waveform shaping effect may be used as the waveform shaping unit 210.

The gate circuit 321 can be constituted by an AND circuit, for example. One input terminal of the AND circuit is connected to the waveform shaping unit 210, and the other input terminal is connected to a drive line GATE. By controlling the supply of a signal to the gate circuit 321, exposure periods to be described below are set. The gate circuit 321 outputs an output signal of the waveform shaping unit 210 to the counter 211 during a period during which a gate signal input via the drive line GATE from the outside of the photoelectric conversion element is at a High (H) level. On the other hand, the gate circuit 321 does not output an output signal of the waveform shaping unit 210 to the counter 211 during a period during which the gate signal is at a Low (L) level. By inputting a pulse during the High (H) level period of nanoseconds to picoseconds, for example, as the gate signal, it is possible to selectively detect only a photon signal that has entered during a subframe period being a period to be observed.

The counter 211 counts the number of pulse signals (the number of times) output from the waveform shaping unit 210, and stores a count value. The counter 211 measures an amount of light that enters a photoelectric conversion element. Depending on a control signal input via a drive line CTRL from the outside of the photoelectric conversion element, the counter 211 switches whether to perform a count operation of the counter 211 and whether to stop the count operation. Examples of the counter 211 include a multibit digital counter, but a one-bit digital memory or an analog memory that uses a capacitative element may be used. The counter 211 and the output circuit 306 are connected by lines corresponding to the number of bits of the counter 211. When a control pulse pRES is supplied via a drive line RES, a signal stored in the counter 211 is reset.

The output circuit 306 receives a selection signal input via a drive line SEL from the outside of the photoelectric conversion element, and outputs, to the signal line 113, a signal output from the counter 211. In the present exemplary embodiment, a control pulse pSEL is supplied from the vertical scanning circuit unit 110 in FIG. 4 via the drive line SEL in FIG. 5, and the electric connection between the counter 211 and the signal line 113 is switched between a connected state and a disconnected state.

The output circuit 306 includes, for example, a buffer circuit for outputting a signal, and for example, a three-state buffer can be used.

A switch, such as a transistor, may be provided between the quench element 202 and the APD 201, and between the photoelectric conversion unit 102 and the signal processing unit 103, to switch the electric connection therebetween. Alternatively, the supply of the voltage VH or the voltage VL to be supplied to the photoelectric conversion unit 102 may be electrically switched using a switch, such as a transistor. Furthermore, by switching a voltage to be input to a gate of the transistor that constitutes the quench element 202, the above-described electric connection may be switched without providing an additional switch.

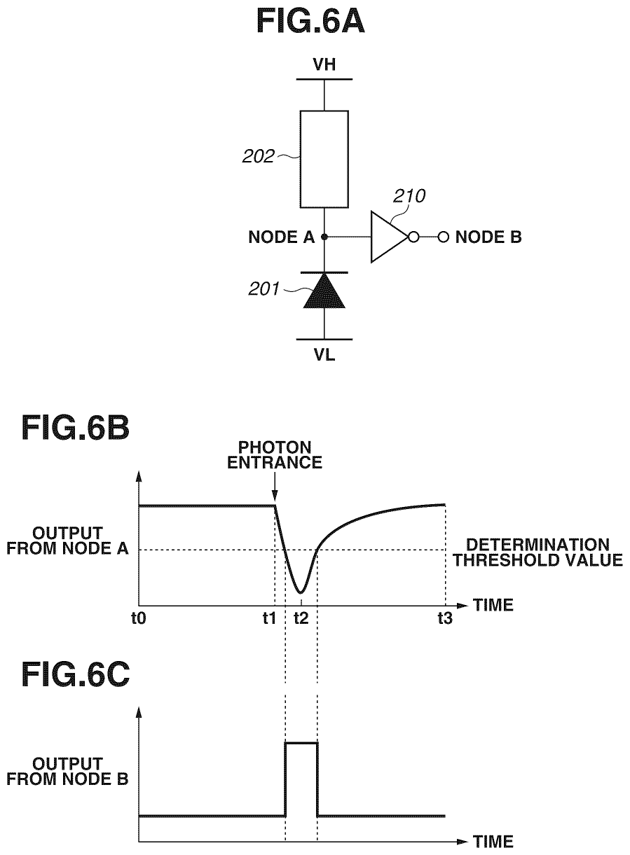

FIGS. 6A to 6C are diagrams schematically illustrating a relationship between an operation of an APD and an output signal.

FIG. 6A is a diagram selectively illustrating the APD 201, the quench element 202, and the waveform shaping unit 210 that are illustrated in FIG. 5. In FIG. 6A, an input side of the waveform shaping unit 210 is regarded as the node A and an output side is regarded as a node B. FIG. 6B illustrates a change in a waveform at the node A in FIGS. 6A, and 6C illustrates a change in a waveform at the node B in FIG. 6A.

During a period from a time t0 to a time t1, a potential difference VH-VL is applied to the APD 201 in FIG. 6A. If a photon enters the APD 201 at the time t1, avalanche multiplication occurs in the APD 201, an avalanche multiplication current flows to the quench element 202, and a voltage at the node A drops. If an amount of voltage drop further increases and a potential difference applied to the APD 201 becomes smaller, avalanche multiplication of the APD 201 stops at a time t2. The voltage at the node A accordingly stops dropping below a certain value. After that, during a period from the time t2 to a time t3, a current flows to the node A from the voltage VL to compensate for the voltage drop, and the potential level at the node A is statically settled at the original potential level at the time t3. At this time, a portion of the output waveform at the node A exceeding a certain threshold value is rectified by the waveform shaping unit 210, and is output as a signal at the node B.

The arrangement of the signal lines 113 and the arrangement of the readout circuit 112 and the output circuit 114 are not limited to those illustrated in FIG. 5. For example, the signal lines 113 may be arranged to extend in a row direction, and the readout circuit 112 may be arranged at the ends of the extending signal lines 113.

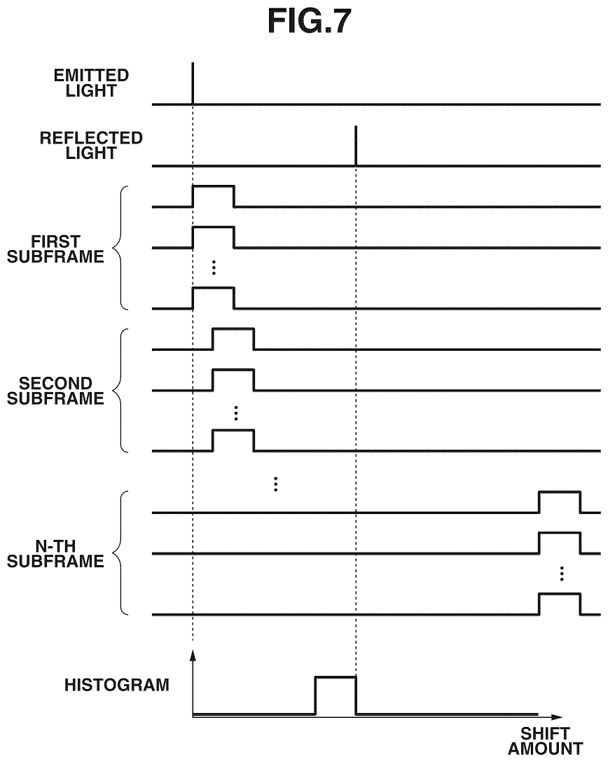

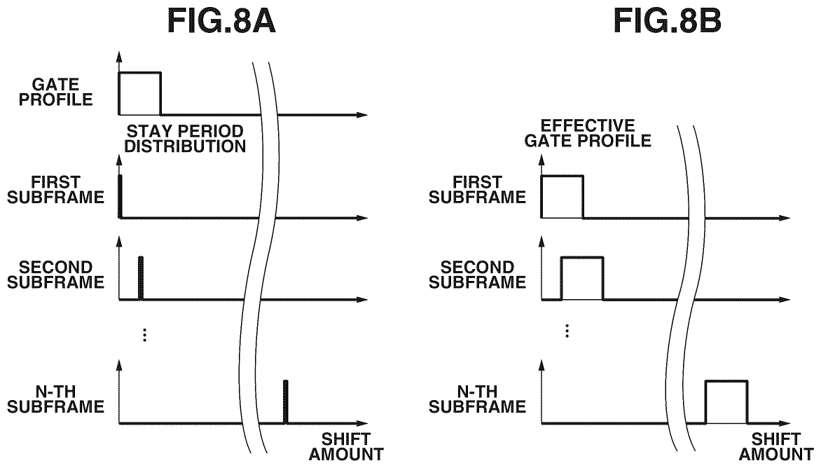

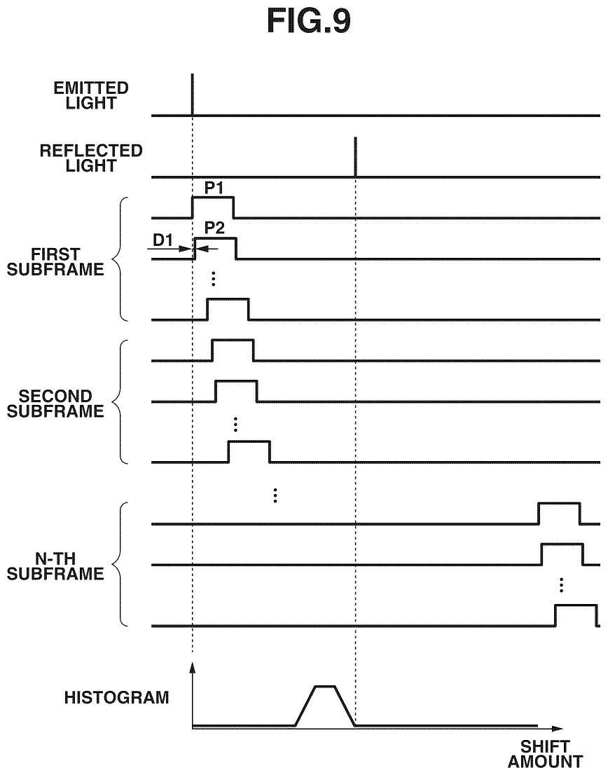

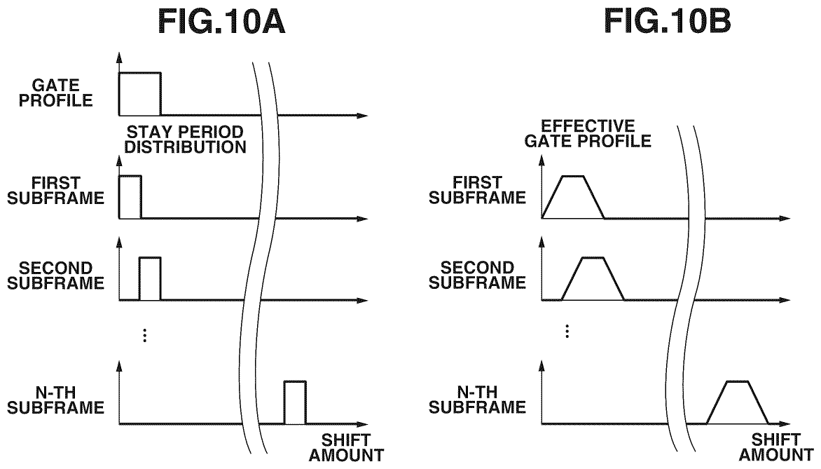

A photoelectric conversion apparatus according to a first exemplary embodiment will be described with reference to FIGS. 9, 10A and 10B. Referring to FIGS. 7 to 8B as a comparative exemplary embodiment, the principle based on which appropriate distance resolution can be ensured without increasing a distance measurement time, which serves as an effect of the preset exemplary embodiment of the present disclosure, will be described with reference to FIGS. 9, 10A and 10B.

FIG. 7 is a driving timing diagram according to a comparative exemplary embodiment, and FIGS. 8A and 8B illustrate graphs indicating gate driving per unit time in driving according to the comparative exemplary embodiment.

In FIG. 7, emitted light indicates a timing at which light is emitted from a light emission element. The reflected light indicates a timing at which light emitted from the light emission element is reflected by a target object and detected by a photoelectric conversion apparatus serving as a signal detection apparatus.

Using signals of N subframes (N is an integer of two or more) including a first subframe and a second subframe, one distance measurement frame is generated. In each subframe, a period at the H level is a period during which light from the light emission element can be detected. In each subframe, a period at the L level is a period during which light from the light emission element cannot be detected. In the present exemplary embodiment, a period during which a signal is at the H level corresponds to an exposure period during which light can be detected by a plurality of photoelectric conversion elements arranged in a photoelectric conversion region, and a period during which a signal is at the L level corresponds to a non-exposure period during which light cannot be detected by the plurality of photoelectric conversion elements. The exposure period refers to a period during which the photoelectric conversion units 102 are active and signals from the photoelectric conversion units 102 are read out by a signal detection circuit such as a counter circuit, for example. The non-exposure period refers to a period during which signals from the photoelectric conversion units 102 are not read out by a signal detection circuit such as a counter circuit.

For example, the exposure period refers to a period during which a gate signal input to a gate circuit via the drive line GATE is at the H level. For example, the non-exposure period refers to a period during which a gate signal input to a gate circuit via the drive line GATE is at the L level. In the driving of resetting the quench element 202 by inputting a cyclic pulse to the drive line VR, the exposure period may be defined as a period until the gate signal switches to the L level after the drive line VR switches to the H level.

The exposure period and the non-exposure period are not limited to the above-described examples. The exposure period may be defined as a period during which a reverse bias potential at which avalanche multiplication can be performed is applied to an APD, a quench element is in a non-quench state, and a signal from the APD can be read out by a signal detection circuit such as a counter. The non-exposure period may be defined as a period during which a quench element is in a quench state, and a signal from an APD is not read out via the quench element. As another example, the non-exposure period may be defined as a period during which a potential difference to be applied to an APD is decreased in order to prevent the occurrence of avalanche multiplication in the APD, and the exposure period may be defined as a period during which a potential difference that causes avalanche multiplication to occur in an APD. Alternatively, the non-exposure period may be defined as a period during which control is performed in such a manner that a signal detection circuit such as a counter is not driven, and the exposure period may be defined as a period during which control is performed in such a manner that a signal detection circuit such as a counter is driven.

A plurality of subframes is generated by the first frame generation unit 37 illustrated in FIG. 1, for example, and a distance measurement frame is generated by the second frame generation unit 38. The first frame generation unit 37 and the second frame generation unit 38 may be arranged in the photoelectric conversion apparatus 100. In this case, for example, the first frame generation unit 37 and the second frame generation unit 38 can be arranged in the readout circuit 112 illustrated in FIG. 4, and distance information can be calculated based on a signal output from an APD. In this case, frame timing generation can be performed by the control pulse generation unit 115.

To make the description easy to understand, in FIG. 7, emitted light, reflected light, and subframes are arranged in a line. Although there is a plurality of timings of the emitted light, one light emission timing in each subframe is illustrated in FIG. 7. Specifically, in the actual driving, based on first emitted light, first light amount measurement of the first subframe is performed. In addition, based on second emitted light, second light amount measurement of the first subframe is performed. Based on m-th (m is an integer of two or more) emitted light, m-th light amount measurement of the first subframe is performed, and based on (m+1)-th emitted light, first light amount measurement of the second subframe is performed. Subsequently, light amount measurement is similarly performed up to the Nth subframe.

As illustrated in FIG. 7, during a period of generating the first subframe, light amount measurement of the first subframe, including the emission of light, is repeatedly performed a plurality of times without changing a timing from the light emission to the start of an exposure period of the first subframe. After that, light amount measurement of the second subframe is performed. A period from the light emission to the start of an exposure period in the light amount measurement of the second subframe is set to a period longer than the period from the light emission to the start of the exposure period in the light amount measurement of the first subframe. Similarly to the light amount measurement of the first subframe, light amount measurement of the second subframe, including the emission of light, is repeatedly performed a plurality of times without changing a timing from the light emission to the start of an exposure period of the second subframe. Then, light amount measurement of the Nth subframe is performed. In the Nth subframe, similarly to the foregoing subframes, light amount measurement of the Nth subframe is performed a plurality of times without changing a timing from the light emission to the start of an exposure period. Based on the results of light amount measurement in a plurality of subframes including the first to Nth subframes, histogram information about reflected light is generated. Based on time information corresponding to a class in which the number of detected photons (frequency) is largest, a distance to a target object is calculated.

In the comparative exemplary embodiment, detection is performed in one subframe a plurality of times with the same start timing and end timing of an exposure period, and in the next subframe, the start timing and the end timing of an exposure period are relatively shifted from the timings in the previous subframe.

FIG. 8A illustrates a gate profile and a stay period distribution in each subframe according to the comparative exemplary embodiment. The gate profile is a function representing a temporal change in sensitivity to incident photons in a single light amount measurement of a predetermined subframe, and in the comparative exemplary embodiment, the gate profile corresponds to a period during which a gate is turned on. In FIG. 8A, for ease of the description, a gate profile is represented by a rectangular function. In reality, due to pulse delay or a finite reset time in a sensor, distortion, overshoot, or ringing may occur in rising and falling waveforms. The stay period distribution refers to a distribution indicating the number of times light for which receiving timings are to be integrated when emitted light and received light are repeatedly measured in a certain subframe. In the comparative exemplary embodiment, because reflected light is measured a plurality of times and integrated with the period from the light emission to the start timing of an exposure period the same in subframes, the stay period distribution indicates a delta function.

FIG. 8B illustrates an effective gate profile obtained by a composition product (convolution) of a gate profile and a stay period distribution according to the comparative exemplary embodiment.

Next, the present exemplary embodiment will be described. FIG. 9 is a driving timing diagram according to the present exemplary embodiment, and FIGS. 10A and 10B illustrate graphs indicating gate driving per unit time in driving according to the present exemplary embodiment.

In FIG. 9, because emitted light, reflected light, each subframe, and histogram are similar to those illustrated in FIG. 7, the description thereof will be omitted.

In FIG. 9, in light amount measurement of each subframe, exposure periods of a plurality of photoelectric conversion elements arranged in an array of a plurality of rows and columns that are included in a signal generation apparatus are simultaneously controlled.

For example, in a photoelectric conversion region, exposure periods of a plurality of photoelectric conversion elements arranged in an array of a rows and columns are simultaneously controlled. Specifically, in at least two or more photoelectric conversion elements of the plurality of photoelectric conversion elements, a first exposure period is simultaneously started, and after that, a second exposure period is simultaneously started. Among the plurality of photoelectric conversion elements, exposure periods of a plurality of photoelectric conversion elements arranged in a region in which signal generation is to be performed are simultaneously controlled.

In the present exemplary embodiment, one subframe includes a first exposure period P1 and a second exposure period P2, and a start timing of the first exposure period P1 and a start timing of the second exposure period P2 are different. The first subframe includes a first exposure period of exposure to be started after a predetermined period from light emission from a light emission element, and a second exposure period of exposure to be started after a period longer than the predetermined period from light emission from the light emission element. Here, the predetermined period includes 0. In the present exemplary embodiment, a period from the light emission from the light emission element up to the start of the second exposure period is shorter than a period from the light emission from the light emission element up to the end of the first exposure period. In other words, in one subframe, the second exposure period includes both of a period that overlaps the first exposure period, and a period that does not overlap the first exposure period. With this configuration, because exposure periods can be overlapped in one subframe, when a histogram is generated, it makes it possible to perform distance measurement with high resolution.

In FIG. 9, in one subframe, a start timing of an exposure period is shifted at a constant speed with respect to a light emission timing of a light source, but the configuration is not limited to this. For example, a start timing of an exposure period may be anomalistically shifted with respect to a light emission timing of a light source.

For example, the first subframe may further include a third exposure period and a fourth exposure period, and period differences between start timings of the first to fourth exposure periods may be made the same or may be made different. A period difference between the start timing of the first exposure period P1 and the start timing of the second exposure period P2 is referred to as a first period difference D1. A period difference between the start timing of the second exposure period P2 and a start timing of the third exposure period is referred to as a second period difference. A period difference between the start timing of the third exposure period and a start timing of the fourth exposure period is referred to as a third period difference. In the present exemplary embodiment, the first period difference, the second period difference, and the third period difference are set to the same length.

A histogram is generated by counting an integrated signal amount obtained by integrating total signal amounts of light amount values obtained in exposure periods in the subframes. In the present exemplary embodiment, using information such as rising, falling, a mode value, or a centroid of the histogram, a time difference from light emission to light reception is calculated. It accordingly makes it possible to measure a distance to a target object.

As illustrated in FIG. 9, in the present exemplary embodiment, a plurality of frames includes a first subframe in which an exposure period is started after a first period from light emission from the light emission element, and a second subframe in which an exposure period is started after a second period longer than the first period from light emission from the light emission element.

Then, any of a plurality of exposure periods in the first subframe and any of a plurality of exposure periods in the second subframe are partially overlapped. A period from light emission from the light emission element up to an end timing of at least one of the plurality of exposure periods in the first subframe is longer than a period from light emission from the light emission element up to a start timing of at least one of the plurality of exposure periods in the second subframe. With this configuration, in the generation of a histogram, an integrated signal amount of the first subframe and an integrated signal amount of the second subframe can be overlapped. The first period is an integer including 0, and the second period is an integer not including 0. In other words, light amount measurement is performed while shifting a start timing of an exposure period with respect to a light emission timing of a light source between subframes. Accordingly, it is possible to improve distance resolution as compared with a case where exposure periods are not overlapped.

FIG. 10A illustrates a gate profile and a stay period distribution in each subframe according to the present exemplary embodiment. The gate profile is a function representing a temporal change in sensitivity to incident photons in a single light amount measurement of a predetermined subframe, and in the present exemplary embodiment, the gate profile corresponds to a period during which a gate is turned on. In FIG. 10A, for ease of the description, a gate profile is represented by a rectangular function. In reality, due to pulse delay or a finite reset time in a sensor, distortion, overshoot, or ringing may occur in rising and falling waveforms. As illustrated in FIG. 10A, according to the present exemplary embodiment, because integration is performed while shifting a light reception timing at a constant speed in a subframe, an integrated stay period distribution is represented by a rectangular function. According to the present exemplary embodiment, it is possible to widen the width of the stay period distribution as compared with that in the comparative exemplary embodiment.

FIG. 10B illustrates an effective gate profile obtained by a composition product (convolution) of a gate profile and a stay period distribution according to the present exemplary embodiment. In the present exemplary embodiment, because the width of the stay period distribution can be made wider as illustrated in FIG. 10A, an effective gate profile obtained by convolution has a shape such as a trapezoid.

According to the present exemplary embodiment, an effective gate profile can take not a binary value but an intermediate value, and a period during which the intermediate value is taken can be overlapped with a part of an effective gate profile of an immediately preceding subframe or an immediately following subframe. With this configuration, based on an internal division ratio of an integrated output in an immediately preceding subframe or an immediately following subframe, it makes it possible to obtain resolution finer than a gate shift interval. Accordingly, it is possible to provide a signal generation apparatus that can ensure appropriate distance resolution without increasing a distance measurement time.

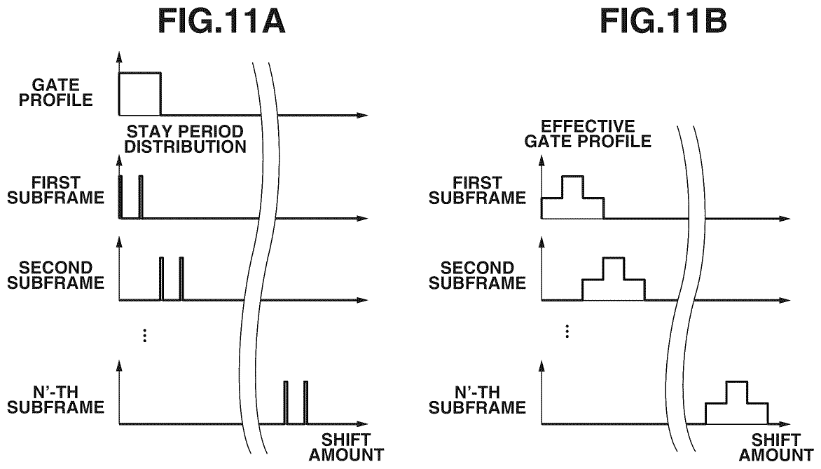

A second exemplary embodiment will be described with reference to FIGS. 11A and 11B. FIGS. 11A and 11B illustrate graphs indicating gate driving per unit time in driving and an effective gate profile according to the present exemplary embodiment. FIG. 11A illustrates a gate profile and a stay period distribution in each subframe, and FIG. 11B illustrates an effective gate profile.

In the first exemplary embodiment, start times of a plurality of exposure periods are shifted at a constant speed in one subframe. The present exemplary embodiment differs from the first exemplary embodiment in that exposure periods are shifted in a binary manner in one subframe at different timings, and exposure is performed a plurality of times at each timing. Except for this point and a point to be described below, the present exemplary embodiment has substantially the same configuration as the first exemplary embodiment. Thus, the description of the other points will be omitted.

In the present exemplary embodiment, in one subframe, a first exposure period of exposure to be started after the lapse of a first period from light emission from the light emission element is repeatedly performed a plurality of times, and a second exposure period of exposure to be started after the lapse of a second exposure period from light emission from the light emission element is repeatedly performed a plurality of times. Then, an integrated signal amount is calculated using signals obtained in a plurality of first exposure periods and signals obtained in a plurality of second exposure periods.

In the present exemplary embodiment, the number of times the first exposure period is repeated and the number of times the second exposure period is repeated are set to the same number. For example, the first exposure period is repeatedly performed ten times, and the second exposure period is repeatedly performed ten times. The number of times is not limited to this. For example, the number of times the first exposure period is repeated and the number of times the second exposure period is repeated may be different. In this case, a distance to a target object is measured based on a histogram that takes into consideration that the number of times the first exposure period is repeated and the number of times the second exposure period is repeated are different. In the present exemplary embodiment, as illustrated in FIG. 11B, an effective gate profile has an inverted-T shape. In other words, the effective gate profile has a protruding shape.

According to the present exemplary embodiment, similarly to the first exemplary embodiment, it is possible to provide a signal generation apparatus that can ensure appropriate distance resolution without increasing a distance measurement time. In addition, it is possible to use a simpler pulse generator than that in the first exemplary embodiment. Accordingly, it makes it possible to achieve a reduction in the cost of the distance information generation apparatus.

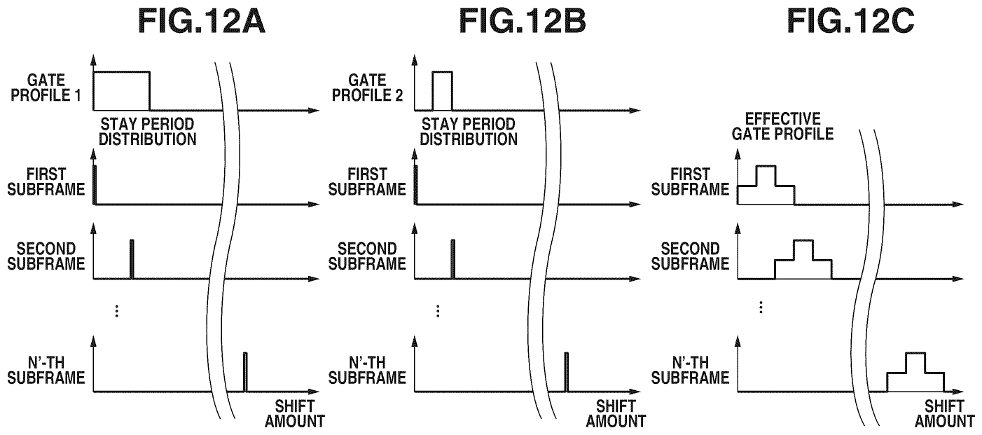

In the present exemplary embodiment, as a modified example, the lengths of the first exposure period and the second exposure period may be varied. FIG. 12A illustrates a gate profile 1 in the first exposure period and FIG. 12B illustrates a gate profile 2 in the second exposure period according to the modified example. In the modified example, the first exposure period is longer than the second exposure period.

FIG. 12C illustrates an effective gate profile obtained by a composition product (convolution) of the gate profile 1, the gate profile 2, and a stay period distribution. In this manner, by performing integration a plurality of times for the gate profile 1 and the gate profile 2 having different widths of the exposure periods and different start timings of the exposure periods, it is also possible to obtain an effective gate profile similar to that illustrated in FIG. 11B. Accordingly, also in the modified example, it is possible to provide a signal generation apparatus that can ensure appropriate distance resolution without increasing a distance measurement time.

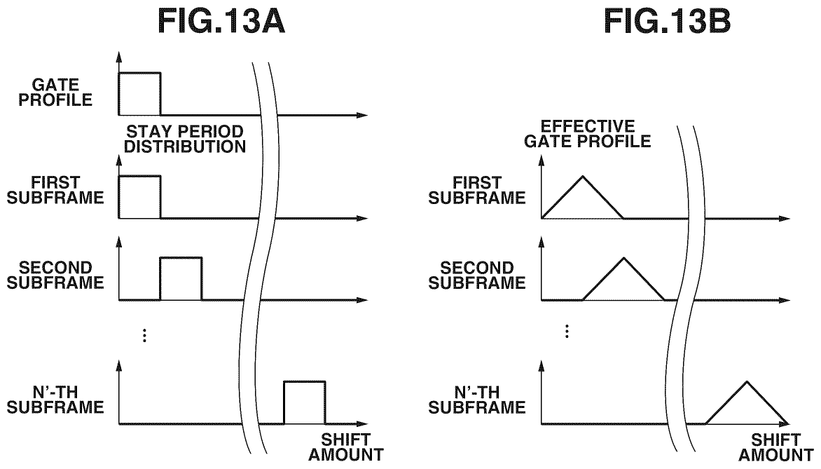

A third exemplary embodiment will be described with reference to with reference to FIGS. 13A and 13B. FIGS. 13A and 13B illustrate graphs indicating gate driving per unit time in driving and an effective gate profile according to the present exemplary embodiment. FIG. 13A illustrates a gate profile and a stay period distribution in each subframe, and FIG. 13B illustrates an effective gate profile.

In the present exemplary embodiment, a plurality of exposure periods in a first subframe and a plurality of exposure periods in a second subframe are shifted. Except for this point and a point to be described below, the present exemplary embodiment is substantially the same as the first exemplary embodiment. Thus, the description will be omitted.

In the present exemplary embodiment, control is performed in such a manner that end timings of a plurality of exposure periods in the first subframe become equal to or later than start timings of a plurality of exposure periods in the second subframe. In addition, a timing difference between subframes is made equal to or smaller than the width of a gate profile. With this configuration, it is possible to encompass a distance measurement range to be observed, using a smaller number of subframes as compared with the first exemplary embodiment. Accordingly, a distance measurement time can be shortened as compared with the first exemplary embodiment. In particular, by making the timing difference nearly equal to the width of the gate profile, an increase/decrease relationship of the effective gate profile can be inverted in an immediately preceding subframe or an immediately following subframe. More specifically, as illustrated in FIG. 13B, a region in which the inclination of the effective gate profile of the first subframe has a negative value can correspond to a region in which the inclination of the effective gate profile of the second subframe has a positive value.

In the present exemplary embodiment, similarly to the first exemplary embodiment, it is possible to provide a signal generation apparatus that can ensure appropriate distance resolution without increasing a distance measurement time. In addition, by acquiring data in a plurality of subframes while maintaining the inverted relationship of the increase/decrease relationship of the effective gate profile, it makes it possible to obtain high resolution irrespective of a distance to a target object.

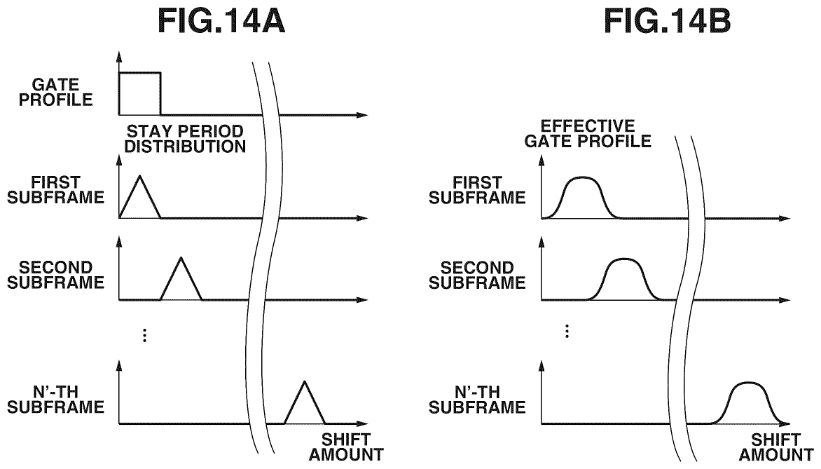

A fourth exemplary embodiment will be described with reference to with reference to FIGS. 14A and 14B. FIGS. 14A and 14B illustrate graphs indicating gate driving per unit time in driving and an effective gate profile according to the present exemplary embodiment. FIG. 14A illustrates a gate profile and a stay period distribution in each subframe, and FIG. 14B illustrates an effective gate profile.

The present exemplary embodiment differs from the first exemplary embodiment in that, in one subframe, a shift amount of a start timing of an exposure period is gradually decreased with the lapse of the period, and thereafter, a shift amount of a start timing of an exposure period is gradually increased with the lapse of the period. Except for this point and a point to be described below, the present exemplary embodiment is substantially the same as the first exemplary embodiment. Thus, the description of the other points will be omitted.

In the present exemplary embodiment, a stay period distribution in each subframe has a bilaterally symmetric triangular shape instead of a rectangular shape. For example, a first period difference and a third period difference are the same, and a second period difference is smaller than the first period difference. Accordingly, as illustrated in FIG. 14B, an effective gate profile has a steeper inclination as compared with the first exemplary embodiment. Accordingly, by causing the light reflected on a target object to lie across an immediately preceding subframe or an immediately following subframe, it is possible to improve distance measurement accuracy as compared with the first exemplary embodiment.

In the present exemplary embodiment, similarly to the first exemplary embodiment, it is possible to provide a signal generation apparatus that can ensure appropriate distance resolution without increasing a distance measurement time. In addition, it is possible to improve distance measurement accuracy as compared with the first exemplary embodiment.

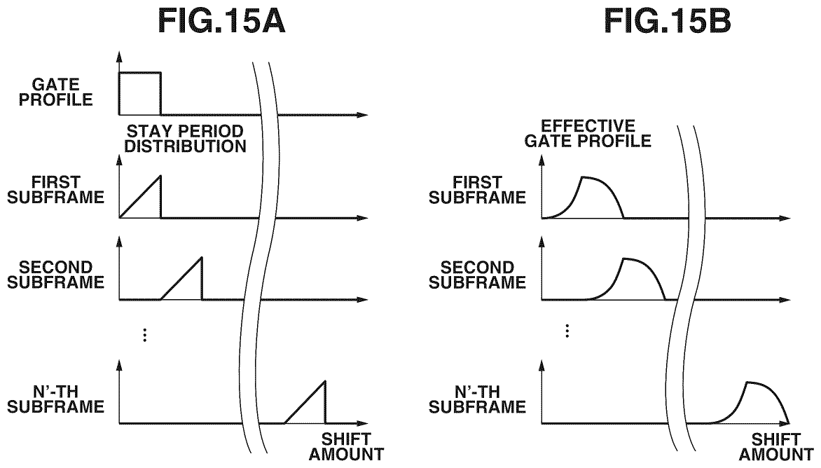

In the present exemplary embodiment, as Modified Example 1, as illustrated in FIG. 15A, a stay period distribution in each subframe may have an asymmetric triangular shape. For example, integration may be performed by gradually decreasing a shift amount of a start timing of an exposure period with the lapse of the period.

In other words, in one subframe, an overlap between a plurality of exposure periods may be increased in the second half of a subframe. A third period difference is smaller than a second period difference, and the second period difference is smaller than a first period difference. In this case, as illustrated in FIG. 15B, an effective gate profile also has a steeper inclination as compared with the first exemplary embodiment. Accordingly, in Modified Example 1, it makes it possible to further improve distance measurement accuracy. A similar stay period distribution may be realized by changing the number of times integration is performed for each start timing of an exposure period while keeping a shift amount constant, instead of gradually decreasing a shift amount of a start timing of an exposure period with the lapse of the period. In this case, the number of times integration is performed in the first exposure period and the number of times integration is performed in the second exposure period are different. For example, the number of times integration is performed in the second exposure period can be larger than the number of times integration is performed in the first exposure period.

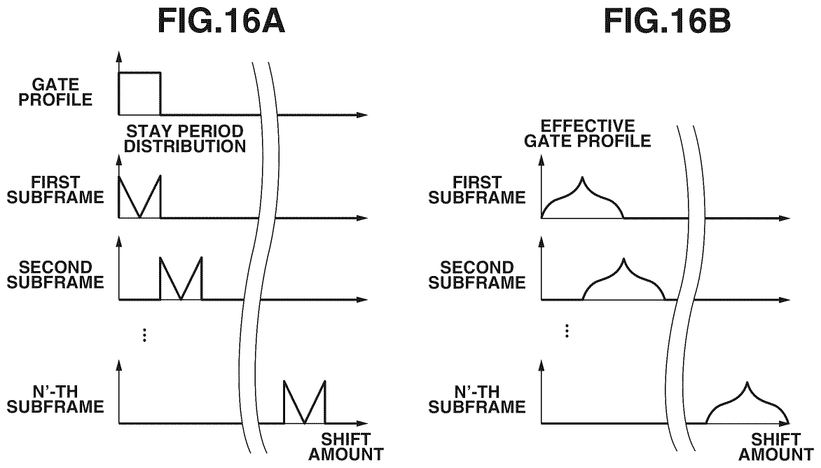

In the present exemplary embodiment, as Modified Example 2, as illustrated in FIG. 16A, a stay period distribution in each subframe may have an M-shape. For example, in one subframe, a shift amount of a start timing of an exposure period may be gradually increased with the lapse of the period, and from a certain midpoint, a shift amount of a start timing of an exposure period may be gradually decreased with the lapse of the period.

In other words, in one subframe, an overlap between a plurality of exposure periods may be increased in the first half and the second half of the subframe, and an overlap between a plurality of exposure periods may be decreased near the center of the subframe. Also in Modified Example 2, as illustrated in FIG. 16B, an effective gate profile has a steeper inclination as compared with the first exemplary embodiment. Accordingly, in Modified Example 2, it makes it possible to further improve distance measurement accuracy.

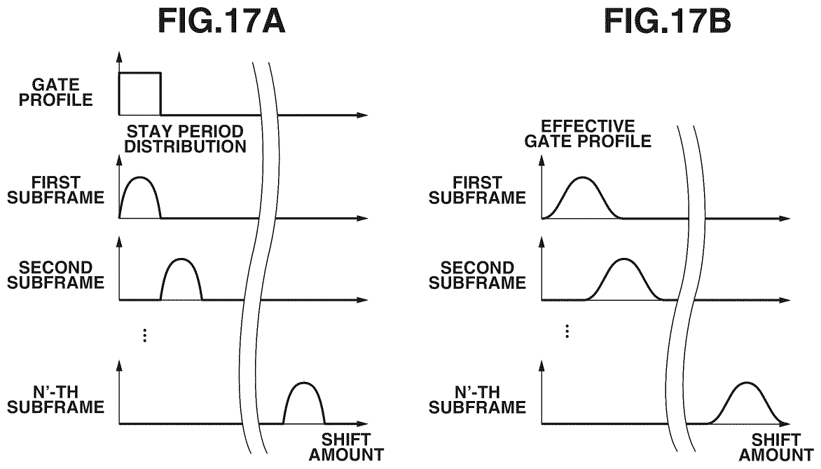

In the present exemplary embodiment, as Modified Example 3, as illustrated in FIG. 17A, a stay period distribution in each subframe may have a parabolic shape. For example, in one subframe, an overlap between a plurality of exposure periods may be increased near the center of the subframe, and an overlap between a plurality of exposure periods may be decreased in the first half and the second half of the subframe. For example, a second period difference may be smaller than a first period difference, and a third period difference may be smaller than the second period difference. In this case, as illustrated in FIG. 17B, an effective gate profile also has a steeper inclination as compared with the first exemplary embodiment. Accordingly, in Modified Example 3, it makes it possible to further improve distance measurement accuracy.

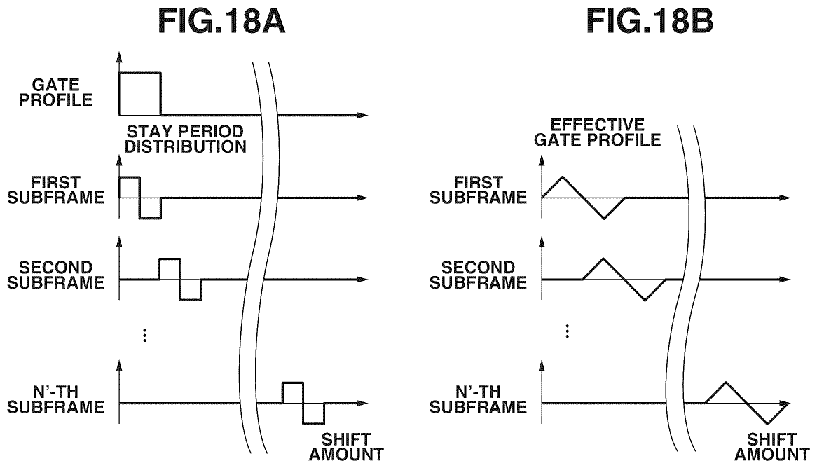

A fifth exemplary embodiment will be described with reference to with reference to FIGS. 18A and 18B. FIGS. 18A and 18B illustrate graphs indicating gate driving per unit time in driving and an effective gate profile according to the present exemplary embodiment. FIG. 18A illustrates a gate profile and a stay period distribution in each subframe, and FIG. 18B illustrates an effective gate profile.

The present exemplary embodiment differs from the first exemplary embodiment in that a counter included in a photoelectric conversion element is an up/down counter. Except for this point and a point to be described below, the present exemplary embodiment is substantially the same as the first exemplary embodiment. Thus, the description of the other points will be omitted.

In the present exemplary embodiment, an up/down counter is used as a counter. With this configuration, counting up and counting down can be switched in one subframe. Accordingly, as illustrated in FIG. 18A, it is possible to effectively take a negative value in a stay period distribution. In an effective gate profile obtained by convolution, a negative value can be also taken. Accordingly, it makes it possible to execute highly accurate distance measurement while cancelling the influence of external light.

In the present exemplary embodiment, similarly to the first exemplary embodiment, it is possible to provide a signal generation apparatus that can ensure appropriate distance resolution without increasing a distance measurement time. In addition, it is possible to reduce the influence of external light as compared with the first exemplary embodiment.

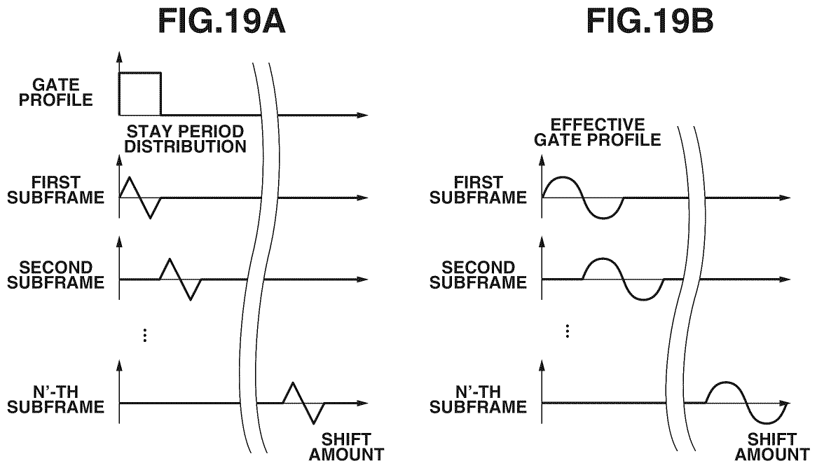

In the present exemplary embodiment, as a modified example, as illustrated in FIG. 19A, a stay period distribution in each subframe may have a triangular shape instead of a rectangular shape. For example, in one subframe, a shift amount of a start timing of an exposure period may be gradually decreased with the lapse of the period, and thereafter, a shift amount of a start timing of an exposure period may be gradually increased with the lapse of the period. In this case, as illustrated in FIG. 19B, an effective gate profile can have a nearly sinusoidal shape. Accordingly, in the case of performing processing that uses the principle of Fourier transformation or the like, subsequent calculation processing can be simplified.

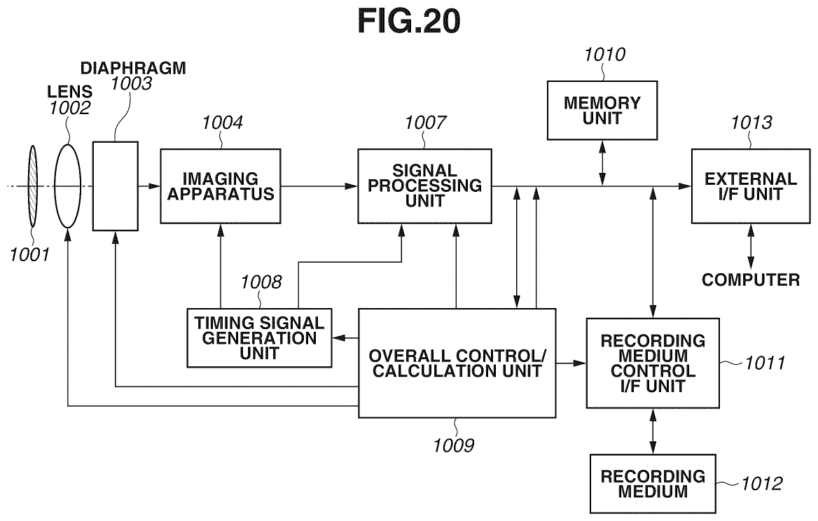

A signal generation system according to a sixth exemplary embodiment will be described with reference to FIG. 20. FIG. 20 is a block diagram illustrating a schematic configuration of a signal generation system according to the present exemplary embodiment.

The signal generation apparatus (photoelectric conversion apparatus) described in the above-described exemplary embodiments can be applied to various signal generation systems. Examples of signal generation systems (photoelectric conversion systems) to which the signal generation apparatus can be applied include a digital still camera, a digital camcorder, a monitoring camera, a copier, a facsimile, a mobile phone, an in-vehicle camera, and an observation satellite. A camera module including an optical system, such as a lens, and an imaging apparatus is also included in the signal generation system. As an example, from among these signal generation systems, FIG. 20 illustrates a block diagram of a digital still camera.

The signal generation system exemplified in FIG. 20 includes an imaging apparatus 1004 serving as an example of the signal generation apparatus, and a lens 1002 that forms an optical image of a subject on the imaging apparatus 1004. The signal generation system further includes a diaphragm 1003 for varying an amount of light passing through the lens 1002, and a barrier 1001 for protecting the lens 1002. The lens 1002 and the diaphragm 1003 serve as an optical system that condenses light onto the imaging apparatus 1004. The imaging apparatus 1004 is the signal generation apparatus (imaging apparatus) according to any of the above-described exemplary embodiments, and converts an optical image formed by the lens 1002 into an electric signal.

The signal generation system further includes a signal processing unit 1007 serving as an image generation unit that generates an image by processing an electric signal output by the imaging apparatus 1004. The signal processing unit 1007 performs an operation of performing various types of correction and compression as appropriate and outputting image data. The signal processing unit 1007 may be formed on a semiconductor substrate on which the imaging apparatus 1004 is provided, or may be formed on another semiconductor substrate different from the semiconductor substrate on which the imaging apparatus 1004 is provided. The imaging apparatus 1004 and the signal processing unit 1007 may be formed on the same semiconductor substrate.

The signal generation system further includes a memory unit 1010 for temporarily storing image data, and an external interface unit (external I/F unit) 1013 for communicating with an external computer. The signal generation system further includes a recording medium 1012 such as a semiconductor memory for recording or reading out captured image data, and a recording medium control interface unit (recording medium control I/F unit) 1011 for performing recording onto or readout from the recording medium 1012. The recording medium 1012 may be built into the signal generation system, or may be detachably attached to the signal generation system.

The signal generation system further includes an overall control/calculation unit 1009 that controls various types of calculation and the entire digital still camera, and a timing signal generation unit 1008 that outputs various timing signals to the imaging apparatus 1004 and the signal processing unit 1007. The timing signals may be input from the outside of the signal generation system. In one embodiment, the signal generation system includes at least the imaging apparatus 1004 and the signal processing unit 1007 that processes an electric signal output from the imaging apparatus 1004.

The imaging apparatus 1004 outputs an imaging signal to the signal processing unit 1007. The signal processing unit 1007 performs predetermined signal processing on the imaging signal output from the imaging apparatus 1004 and outputs image data. The signal processing unit 1007 generates an image using the imaging signal.

In this manner, according to the present exemplary embodiment, a signal generation system to which the signal generation apparatus (imaging apparatus) according to any of the above-described exemplary embodiments is applied can be realized.

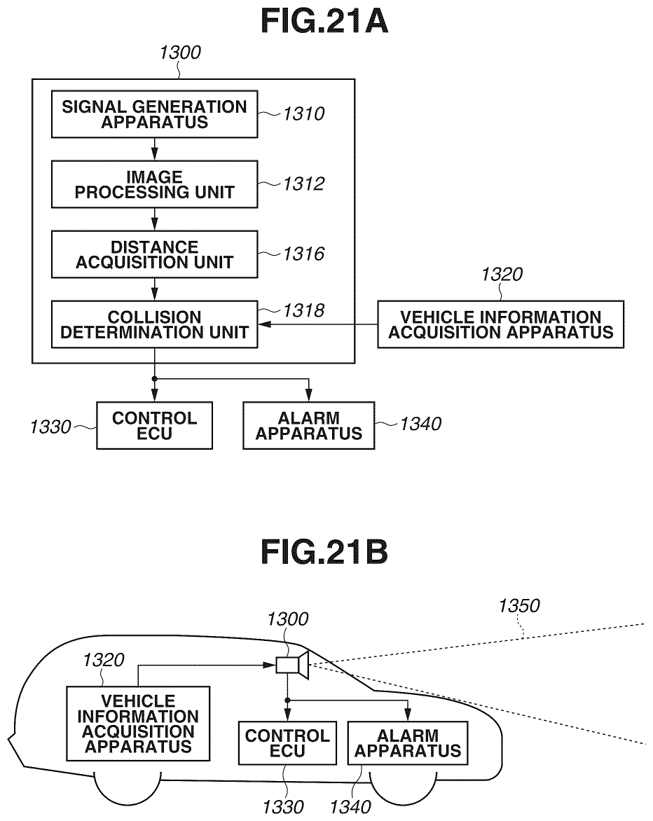

A signal generation system and a movable body according to a seventh exemplary embodiment will be described with reference to FIGS. 21A and 21B. FIGS. 21A and 21B are diagrams illustrating configurations of the signal generation system and the movable body according to the present exemplary embodiment.

FIG. 21A illustrates an example of a signal generation system related to an in-vehicle camera. A signal generation system 1300 includes a signal generation apparatus 1310. The signal generation apparatus 1310 is the signal generation apparatus described in any of the above-described exemplary embodiments. The signal generation system 1300 includes an image processing unit 1312 that performs image processing on a plurality of pieces of image data acquired by the signal generation apparatus 1310. The signal generation system 1300 further includes a distance acquisition unit 1316 that calculates a distance to a target object, and a collision determination unit 1318 that determines whether collision is likely to occur, based on the calculated distance. In this example, the distance acquisition unit 1316 may acquire distance information regarding a distance to a ToF target object, or may acquire distance information using parallax information. More specifically, the distance information is information regarding a parallax, a defocus amount, or a distance to a target object. The collision determination unit 1318 may determine the likelihood of collision using any of these pieces of distance information. The distance information acquisition unit may be implemented by dedicatedly designed hardware, or may be implemented by a software module. Alternatively, the distance information acquisition unit may be implemented by a field programmable gate array (FPGA) or an application specific integrated circuit (ASIC), or may be implemented by the combination of these.

The signal generation system 1300 is connected with a vehicle information acquisition apparatus 1320, and can acquire vehicle information such as a vehicle speed, a yaw rate, or a rudder angle. The signal generation system 1300 is also connected with a control electronic control unit (ECU) 1330. The control ECU 1330 serves as a control apparatus that outputs a control signal for generating braking force of a vehicle based on a determination result obtained by the collision determination unit 1318. The signal generation system 1300 is also connected with an alarm apparatus 1340 that raises an alarm to a driver based on a determination result obtained by the collision determination unit 1318. For example, in a case where the determination result obtained by the collision determination unit 1318 indicates a high likelihood of collision, the control ECU 1330 performs vehicle control to avoid collision and reduce damages by braking, releasing an accelerator, or reducing engine output. The alarm apparatus 1340 issues an alarm to a user by sounding an alarm such as sound, displaying warning information on a screen of a car navigation system, or vibrating a seatbelt or a steering wheel.

In the present exemplary embodiment, the signal generation system 1300 captures an image of the periphery of the vehicle, such as the front side or the rear side of the vehicle, for example. FIG. 21B illustrates the signal generation system 1300 for capturing an image of the front side of the vehicle (imaging range 1350). The vehicle information acquisition apparatus 1320 issues an instruction to the signal generation system 1300 or the signal generation apparatus 1310. With this configuration, the accuracy of distance measurement can be further enhanced.

The above description has been given of an example in which control is performed in such a manner as not to collide with another vehicle. The signal generation system can also be applied to a case of performing automatic operation control that allows a vehicle to follow another vehicle, or a case of performing automatic operation control that prevents a vehicle from drifting from a lane. In addition to a vehicle, such as an automobile, the signal generation system can be applied to a movable body (movable apparatus), such as a vessel, an aircraft, or an industrial robot, for example. This movable body includes either one or both of a drive force generation unit that generates drive force to be mainly used for the movement of the movable body, and a rotating body to be mainly used for the movement of the movable body. The drive force generation unit can be an engine, a motor, or the like. The rotating body can be a tire, a wheel, a screw of a ship, a propeller of a flight vehicle, or the like. Moreover, in addition to a movable body, the signal generation system can be applied to a wide variety of devices that use object recognition, such as an intelligent transport system (ITS).

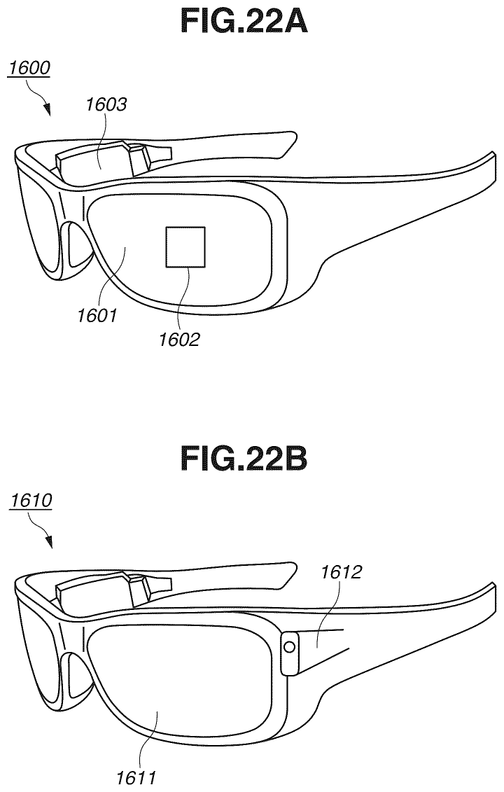

A signal generation system according to an eighth exemplary embodiment will be described with reference to FIGS. 22A and 22B. Referring to FIG. 22A, eyeglasses 1600 (smart glasses) serving as a signal generation system according to the present exemplary embodiment will be described. The eyeglasses 1600 include a signal generation apparatus 1602. The signal generation apparatus 1602 is the signal generation apparatus described in each of the above-described exemplary embodiments. A display device including a light emission apparatus such as an organic light emitting diode (OLED) or a light-emitting diode (LED) may be provided on the back surface of each lens 1601. The number of signal generation apparatuses 1602 may be one or more. A plurality of types of signal generation apparatuses may be used in combination. An arrangement position of the signal generation apparatus 1602 is not limited to the position illustrated in FIG. 22A.

The eyeglasses 1600 further include a control apparatus 1603. The control apparatus 1603 functions as a power source that supplies power to the signal generation apparatus 1602 and the above-described display device. The control apparatus 1603 controls operations of the signal generation apparatus 1602 and the display device. In the lens 1601, an optical system for condensing light to the signal generation apparatus 1602 is formed.

FIG. 22B illustrates eyeglasses 1610 (smart glasses) according to one application example. The eyeglasses 1610 include a control apparatus 1612, and the control apparatus 1612 is equipped with a signal generation apparatus equivalent to the signal generation apparatus 1602, and a display device. In each lens 1611, an optical system for projecting light emitted from the signal generation apparatus and the display device of the control apparatus 1612 is formed, and an image is projected onto the lens 1611. The control apparatus 1612 functions as a power source that supplies power to the signal generation apparatus and the display device, and controls operations of the signal generation apparatus and the display device. The control apparatus 1612 may include a line-of-sight detection unit that detects a line of sight of a wearer. Infrared light may be used for the detection of a line of sight. An infrared light emission unit emits infrared light onto an eyeball of a user gazing at a displayed image. An imaging unit including a light receiving element detects reflected light of the emitted infrared light that has been reflected by the eyeball. A captured image of the eyeball is thereby obtained. Providing a reduction unit for reducing light from the infrared light emission unit to a display unit in a planar view suppresses a decline in image quality.

From a captured image of an eyeball obtained by image capturing using infrared light, a line of sight of a user with respect to a displayed image is detected. Any known method can be applied to line-of-sight detection that uses a captured image of an eyeball. As an example, a line-of-sight detection method that is based on a Purkinje image obtained by reflection of light emitted onto a cornea can be used.

More specifically, line-of-sight detection processing that is based on the pupil center corneal reflection is performed. A line-of-sight vector representing the direction (rotational angle) of the eyeball is calculated based on an image of a pupil that is included in the captured image of the eyeball and the Purkinje image, using the pupil center corneal reflection, and a visual line of a user is thereby detected.

The display device according to the present exemplary embodiment may include the signal generation apparatus including a light receiving element, and a displayed image on the display device may be controlled based on line-of-sight information on the user from the signal generation apparatus.

Specifically, in the display device, a first field-of-view region to be gazed by the user, and a second field-of-view region other than the first field-of-view region are determined based on the visual line information. The first field-of-view region and the second field-of-view region may be determined by a control apparatus of the display device, or the first field-of-view region and the second field-of-view region determined by an external control apparatus may be received. In a display region of the display device, a display resolution of the first field-of-view region may be controlled to be higher than a display resolution of the second field-of-view region. In other word, a resolution of the second field-of-view region may be made lower than a resolution of the first field-of-view region.

The display region includes a first display region and a second display region different from the first display region. Based on the line-of-sight information, a region with high priority may be determined from the first display region and the second display region. The first display region and the second display region may be determined by a control apparatus of the display device, or the first display region and the second display region determined by an external control apparatus may be received. A resolution of a region with high priority may be controlled to be higher than a resolution of a region other than the region with high priority. In other words, a resolution of a region with relatively low priority may be set to a low resolution.

Artificial intelligence (AI) may be used to determine the first field-of-view region and the region with high priority. The AI may be a model configured to estimate an angle of a line of sight and a distance to a target existing in the line of sight from an image of an eyeball using, as teaching data, an image of the eyeball, and a direction in which the eyeball in the image actually gazes. An AI program may be included in the display device, may be included in the signal generation apparatus, or may be included in an external apparatus. In a case where an external apparatus includes an AI program, the AI program is transmitted to the display device via communication.

In a case where display control is performed based on line-of-sight detection, the present exemplary embodiment can be applied to a smart glasses further including a signal generation apparatus that captures an image of the outside. The smart glasses can display external information obtained by image capturing, in real time.

The above-described signal generation apparatus and signal generation system may be applied to an electronic device, such as a smartphone and a tablet, for example.

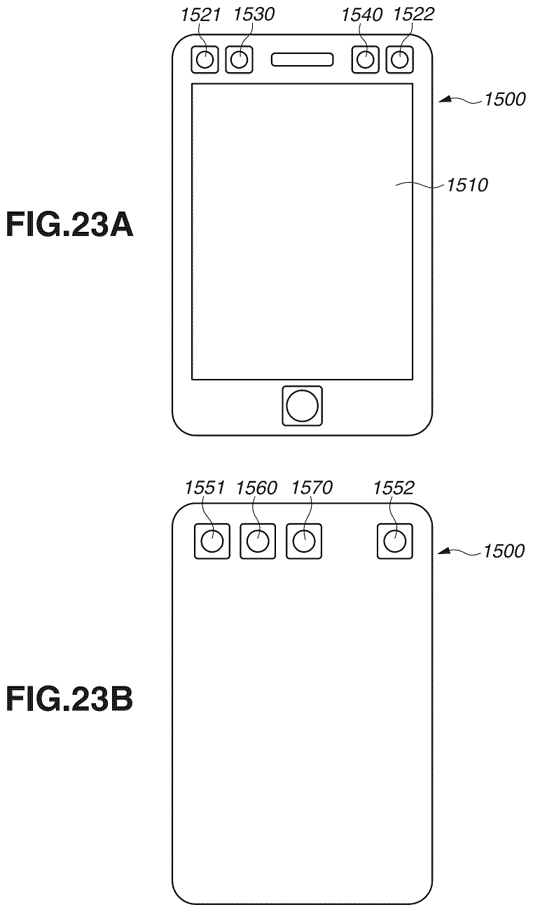

FIGS. 23A and 23B are diagrams illustrating an example of an electronic device 1500 on which a signal generation apparatus is mounted. FIG. 23A illustrates a front surface side of the electronic device 1500 and FIG. 23B illustrates a rear surface side of the electronic device 1500.

As illustrated in FIG. 23A, a display 1510 for displaying an image is arranged at the center on the front surface of the electronic device 1500. Then, along an upper side of the front surface of the electronic device 1500, front cameras 1521 and 1522 in which signal generation apparatuses are used, an IR light source 1530 that emits infrared light, and a visible light source 1540 that emits visible light are arranged.

As illustrated in FIG. 23B, along an upper side of the rear surface of the electronic device 1500, rear cameras 1551 and 1552 in which signal generation apparatuses are used, an IR light source 1560 that emits infrared light, and a visible light source 1570 that emits visible light are arranged.

In the electronic device 1500 having such a configuration, the above-described signal generation apparatus is used, which makes it possible to capture a higher quality image with the distance to a target object taken into account, for example.

In addition to the above, the signal generation apparatus can be applied to an electronic device such as an infrared sensor, a distance measurement sensor that uses an active infrared light source, a security camera, or a person or biometric authentication camera. The signal generation apparatus can enhance the accuracy and performance of these electronic.

In this specification, the wording such as “A or B” and “at least one of A and B” can include all possible combinations of listed items, unless otherwise explicitly defined. In addition, the wording such as “at least one of A or/and B” and “one or more of A or/and B” can include all possible combinations of listed items, unless otherwise explicitly defined. That is, the above-described wording is interpreted as disclosing all of a case where at least one A is included, a case where at least one B is included, and a case where both of at least one A and at least one B are included. The same applies to a combination of three or more components.

The exemplary embodiments described above can be appropriately changed without departing from the technical idea. The disclosure in this specification is not limited to the matters described in this specification, and includes all matters that can be conceived from this specification and the drawings accompanying this specification. The disclosure in this specification includes a complementary set of individual concepts described in this specification. More specifically, in a case where “A is larger than B” is described in this specification, even if the description “B is not larger than A” is omitted, it is considered that this specification discloses that “B is not larger than A”. This is because, in a case where “A is larger than B” is described, it is predicated upon a case where “B is not larger than A”.

The disclosure of the exemplary embodiments described above includes the following configurations and method.

### (Configuration 1)

A signal generation apparatus comprising:
a plurality of photoelectric conversion elements,
wherein the signal generation apparatus generates a plurality of subframes using signals from the plurality of photoelectric conversion elements, and generates a distance measurement frame using signals of the plurality of subframes,
wherein the plurality of subframes includes at least a first subframe in which an exposure period is started after a lapse of a first period after light emission from a light emission element, and a second subframe in which an exposure period is started after a lapse of a second period longer than the first period after the light emission from the light emission element,
wherein the first subframe includes at least a first exposure period and a second exposure period,
wherein a start timing of the first exposure period and a start timing of the second exposure period are different.

### (Configuration 2)

The signal generation apparatus according to Configuration 1, wherein a period from the light emission from the light emission element up to a start of the second exposure period is shorter than a period from the light emission from the light emission element up to an end of the first exposure period.

### (Configuration 3)

The signal generation apparatus according to Configuration 1 or 2,
wherein the plurality of subframes is generated by a first frame generation unit, and
wherein the distance measurement frame is generated by a second frame generation unit.

### (Configuration 4)

The signal generation apparatus according to any one of Configurations 1 to 3,
wherein the first subframe includes a plurality of exposure periods including the first exposure period and the second exposure period, and
wherein, in the first subframe, start timings of the plurality of exposure periods are shifted at a constant speed.

### (Configuration 5)

The signal generation apparatus according to any one of Configurations 1 to 3, wherein, in the first subframe, the first exposure period and the second exposure period are each repeated a plurality of times.

### (Configuration 6)

The signal generation apparatus according to Configuration 5, wherein an integrated signal amount obtained by integrating light amount values obtained by repeating the first exposure period a plurality of times, and light amount values obtained by repeating the second exposure period a plurality of times is counted.

### (Configuration 7)

The signal generation apparatus according to any one of Configurations 1 to 6, wherein a period from the light emission from the light emission element up to an end timing of the exposure period in the first subframe is longer than a period from the light emission from the light emission element up to a start timing of the exposure period in the second subframe.

### (Configuration 8)

The signal generation apparatus according to any one of Configurations 1 to 7, wherein, in at least two or more photoelectric conversion elements of the plurality of photoelectric conversion elements, the second exposure period is simultaneously started.

### (Configuration 9)

The signal generation apparatus according to any one of Configurations 1 to 8,
wherein the first subframe includes a third exposure period and a fourth exposure period,
wherein the first subframe includes a first period difference between the start timing of the first exposure period and the start timing of the second exposure period, a second period difference between the start timing of the second exposure period and a start timing of the third exposure period, and a third period difference between the start timing of the third exposure period and a start timing of the fourth exposure period, and
wherein the first period difference and the third period difference are same, and the second period difference is less than the first period difference.

### (Configuration 10)

The signal generation apparatus according to any one of Configurations 1 to 8,
wherein the first subframe includes a third exposure period and a fourth exposure period,
wherein the first subframe includes a first period difference between the start timing of the first exposure period and the start timing of the second exposure period, a second period difference between the start timing of the second exposure period and a start timing of the third exposure period, and a third period difference between the start timing of the third exposure period and a start timing of the fourth exposure period, and
wherein the first period difference is greater than the second period difference, and the second period difference is greater than the third period difference.

### (Configuration 11)

The signal generation apparatus according to any one of Configurations 1 to 8,
wherein the first subframe includes a third exposure period and a fourth exposure period,
wherein the first subframe includes a first period difference between the start timing of the first exposure period and the start timing of the second exposure period, a second period difference between the start timing of the second exposure period and a start timing of the third exposure period, and a third period difference between the start timing of the third exposure period and a start timing of the fourth exposure period, and
wherein the third period difference is less than the second period difference, and the second period difference is less than the first period difference.

### (Configuration 12)

The signal generation apparatus according to any one of Configurations 1 to 11,
wherein the plurality of photoelectric conversion elements each includes an avalanche photodiode, and a gate circuit configured to control whether to output a signal of the avalanche photodiode, and
wherein the first exposure period and the second exposure period are set by controlling a signal to be supplied to the gate circuit.

### (Configuration 13)

The signal generation apparatus according to Configuration 12,
wherein the gate circuit is an AND circuit, and
wherein a signal from the avalanche photodiode and a signal from ac drive line are input to the AND circuit.

### (Configuration 14)

The signal generation apparatus according to Configuration 12 or 13, wherein the plurality of photoelectric conversion elements each includes a counter.

### (Configuration 15)

The signal generation apparatus according to Configuration 14, wherein the counter is an up/down counter.

### (Configuration 16)

The signal generation apparatus according to any one of Configurations 1 to 15,
wherein a plurality of times of first exposure periods is integrated, and a plurality of times of second exposure periods is integrated, and
wherein an integrated number of times of the first exposure periods and an integrated number of times of the second exposure periods are different.

### (Configuration 17)

The signal generation apparatus according to Configuration 16, wherein the integrated number of times of the second exposure periods is greater than the integrated number of times of the first exposure periods.

### (Configuration 18)

A signal generation system comprising:
a light emission apparatus including the light emission element; and
the signal generation apparatus according to any one of Configurations 1 to 17,
wherein the signal generation apparatus detects reflected light of light emitted from the light emission apparatus and reflected by a target object.

According to the present disclosure, it is possible to provide a signal generation apparatus that can ensure appropriate distance resolution without increasing a distance measurement time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-206843, filed Dec. 7, 2023, which is hereby incorporated by reference herein in its entirety.

What is claimed is:

1. An apparatus comprising:
a plurality of photoelectric conversion elements,
wherein the apparatus generates a plurality of subframes using signals from the plurality of photoelectric conversion elements, and generates a distance measurement frame using signals of the plurality of subframes,
wherein the plurality of subframes includes at least a first subframe in which an exposure period is started after a lapse of a first period after light emission from a light emission element, and a second subframe in which an exposure period is started after a lapse of a second period longer than the first period after the light emission from the light emission element,
wherein the first subframe includes at least a first exposure period and a second exposure period,
wherein a start timing of the first exposure period and a start timing of the second exposure period are different, and
wherein a period from the light emission from the light emission element up to a start of the second exposure period is shorter than a period from the light emission from the light emission element up to an end of the first exposure period.

2. The apparatus according to claim 1,
wherein the plurality of subframes is generated by a first generation unit, and
wherein the distance measurement frame is generated by a second generation unit.

3. The apparatus according to claim 1,
wherein the first subframe includes a plurality of exposure periods including the first exposure period and the second exposure period, and
wherein, in the first subframe, start timings of the plurality of exposure periods are shifted at a constant speed.

4. The apparatus according to claim 1, wherein, in the first subframe, the first exposure period and the second exposure period are each repeated a plurality of times.

5. The apparatus according to claim 4, wherein an integrated signal amount obtained by integrating light amount values obtained by repeating the first exposure period a plurality of times, and light amount values obtained by repeating the second exposure period a plurality of times is counted.

6. The apparatus according to claim 1, wherein a period from the light emission from the light emission element up to an end timing of the exposure period in the first subframe is longer than a period from the light emission from the light emission element up to a start timing of the exposure period in the second subframe.

7. The apparatus according to claim 6, wherein, in at least two or more photoelectric conversion elements of the plurality of photoelectric conversion elements, the second exposure period is simultaneously started.

8. The apparatus according to claim 1,
wherein the first subframe includes a third exposure period and a fourth exposure period,
wherein the first subframe includes a first period difference between the start timing of the first exposure period and the start timing of the second exposure period, a second period difference between the start timing of the second exposure period and a start timing of the third exposure period, and a third period difference between the start timing of the third exposure period and a start timing of the fourth exposure period, and
wherein the first period difference and the third period difference are same, and the second period difference is less than the first period difference.

9. The apparatus according to claim 1,
wherein the first subframe includes a third exposure period and a fourth exposure period,
wherein the first subframe includes a first period difference between the start timing of the first exposure period and the start timing of the second exposure period, a second period difference between the start timing of the second exposure period and a start timing of the third exposure period, and a third period difference between the start timing of the third exposure period and a start timing of the fourth exposure period, and
wherein the third period difference is less than the second period difference, and the second period difference is less than the first period difference.

10. The apparatus according to claim 1,
wherein the first subframe includes a third exposure period and a fourth exposure period,
wherein the first subframe includes a first period difference between the start timing of the first exposure period and the start timing of the second exposure period, a second period difference between the start timing of the second exposure period and a start timing of the third exposure period, and a third period difference between the start timing of the third exposure period and a start timing of the fourth exposure period, and
wherein the first period difference is greater than the second period difference, and the second period difference is less than the third period difference.

11. The apparatus according to claim 1,
wherein the plurality of photoelectric conversion elements each includes an avalanche photodiode, and a gate circuit configured to control whether to output a signal of the avalanche photodiode, and
wherein the first exposure period and the second exposure period are set by controlling a signal to be supplied to the gate circuit.

12. The apparatus according to claim 11,
wherein the gate circuit is an AND circuit, and
wherein a signal from the avalanche photodiode and a signal from a drive line are input to the AND circuit.

13. The apparatus according to claim 11, wherein the plurality of photoelectric conversion elements each includes a counter.

14. The apparatus according to claim 13, wherein the counter is an up/down counter.

15. The apparatus according to claim 1,
wherein a plurality of times of first exposure periods is integrated, and a plurality of times of second exposure periods is integrated, and
wherein an integrated number of times of the first exposure periods and an integrated number of times of the second exposure periods are different.

16. The apparatus according to claim 15, wherein the integrated number of times of the second exposure periods is greater than the integrated number of times of the first exposure periods.

17. An apparatus comprising:
a plurality of photoelectric conversion elements,
wherein the apparatus generates a plurality of subframes using signals from the plurality of photoelectric conversion elements, and generates a distance measurement frame using signals of the plurality of subframes,
wherein the plurality of subframes includes at least a first subframe in which an exposure period is started after a lapse of a first period after light emission from a light emission element, and a second subframe in which an exposure period is started after a lapse of a second period longer than the first period after the light emission from the light emission element,
wherein the first subframe includes at least a first exposure period and a second exposure period,
wherein a start timing of the first exposure period and a start timing of the second exposure period are different,
wherein the plurality of photoelectric conversion elements each includes an avalanche photodiode, and a gate circuit configured to control whether to output a signal of the avalanche photodiode, and
wherein the first exposure period and the second exposure period are set by controlling a signal to be supplied to the gate circuit.

18. The apparatus according to claim 17,
wherein the first subframe includes a plurality of exposure periods including the first exposure period and the second exposure period, and
wherein, in the first subframe, start timings of the plurality of exposure periods are shifted at a constant speed.

19. The apparatus according to claim 17, wherein a period from the light emission from the light emission element up to an end timing of the exposure period in the first subframe is longer than a period from the light emission from the light emission element up to a start timing of the exposure period in the second subframe.

20. The apparatus according to claim 19, wherein, in at least two or more photoelectric conversion elements of the plurality of photoelectric conversion elements, the second exposure period is simultaneously started.

21. The apparatus according to claim 17,
wherein the gate circuit is an AND circuit, and
wherein a signal from the avalanche photodiode and a signal from a drive line are input to the AND circuit.

22. The apparatus according to claim 17, wherein the plurality of photoelectric conversion elements each includes a counter.

23. The apparatus according to claim 17,
wherein a plurality of times of first exposure periods is integrated, and a plurality of times of second exposure periods is integrated, and
wherein an integrated number of times of the first exposure periods and an integrated number of times of the second exposure periods are different.

24. The apparatus according to claim 23, wherein the integrated number of times of the second exposure periods is greater than the integrated number of times of the first exposure periods.

25. A system comprising:
a light emission apparatus including the light emission element; and
the apparatus according to claim 1,
wherein the apparatus detects reflected light of light emitted from the light emission apparatus and reflected by a target object.

26. A system comprising:
a light emission apparatus including the light emission element; and
the apparatus according to claim 17,
wherein the apparatus detects reflected light of light emitted from the light emission apparatus and reflected by a target object.
